(19) United States
(12) Patent Application Publication
(10) Pub. No.: US 2025/0350212 A1
(43) Pub. Date: Nov. 13, 2025

(54) PHASE-SHIFT DISCONTINUOUS PULSE-WIDTH MODULATION METHOD AND THREE-PHASE CONVERTER

(71) Applicant: SHENZHEN VMAX NEW ENERGY (GROUP) CO.,LTD, Shenzhen (CN)

(72) Inventors: Jun LIU, Shenzhen (CN); Jinzhu XU, Shenzhen (CN); Rui HUANG, Shenzhen (CN); Haibin CAO, Shenzhen (CN)

(21) Appl. No.: 18/799,090

(22) Filed: Aug. 9, 2024

(30) Foreign Application Priority Data
May 10, 2024 (CN) 202410577519.X

(51) Int. Cl. H02M 7/219

(52) U.S. Cl. CPC H02M 7/219

(57) ABSTRACT

The present invention discloses a phase-shift discontinuous pulse-width modulation method and a three-phase converter. The method includes: enabling a switching element of an one-phase leg unit to keep switched on or switched off in any switching cycle, and enabling a phase shift ratio ΔΦ to occur between driving signals of switching elements of the other two one-phase leg units, during operation of a three-phase converter, so that an upper-leg switching element of each one-phase leg unit in a three-phase leg assembly is asynchronously switched on or switched off at any time-point. The present invention optimizes the efficiency of the three-phase converter on the basis of simplifying a design for sampling circuits and optimizing costs.

### CROSS-REFERENCE TO RELATED PATENT APPLICATION

This application claims priority to and the benefit of Chinese Patent Application No. CN202410577519.X filed in China on May 10, 2024. The disclosure of the above application is incorporated herein in its entirety by reference.

### FIELD OF THE INVENTION

The present invention relates to the technical field of discontinuous pulse-width modulation, in particular a phase-shift discontinuous pulse-width modulation method and a three-phase converter.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The three-phase converter acting as an interface circuit between a DC network and an AC network has always played an important role in power electronics technology. In recent decades, industry and academia circles have been conducting research on these two types of converters, acquiring a large number of academic achievements and technical solutions, among which an important research direction undoubtedly consists in optimizing the efficiency and cost of these two types of converters.

In the prior art, a three-phase converter topology may be simplified as FIG. 1. A discontinuous pulse width modulation (DPWM) strategy is considered as a well-developed and reliable efficiency optimization. The DPWM modulation strategy can enable a converter not to actuate a switching element of an one-phase leg unit or a two-phase leg unit at a peak value and a valley value of an AC-side current, greatly reducing the switching loss of the converter. In the case of adopting the existing DPWM modulation strategy, a common-mode voltage with a large amplitude occurs between a mid-point M of a DC-side capacitor and a neutral point N of an AC-side filter capacitor, making it necessary to isolate a DC-side sampling circuit from an AC-side sampling circuit by means of an isolation circuit, so as to make a hardware circuit operate safely and stably. Additional costs arising from the isolation circuit undoubtedly limit the application of the DPWM modulation technology in three-phase converters.

Because current power electronic converters trend to have a high frequency and a high-power density, processes such as metal housings and multilayer PCB structures are widely used in the power electronic products. The journal “Analysis and Improvement of the Effect Distributed Parasitic Capacitance on High-Frequency High-Density Three-Phase Buck Rectifier” points out that these processes will establish a common-mode interference path between the AC and DC-sides of the three-phase converter, which severely deteriorates the quality of AC-side currents. Therefore, in general, it is necessary to add a common-mode suppressor circuit to reduce the influence of common-mode interference on the quality of AC-side currents, and the common-mode (CM) suppressor circuit is composed by common-mode filter capacitors Cp and Cn, and a common-mode suppressor unit (CMSU), as shown in FIG. 2. However, in the case of adopting the existing DPWM modulation strategy, it is possible to introduce a big common-mode voltage vMN between M and N points, which generates a common-mode current on the common-mode suppressor unit; thus, the common-mode current circulates via an AC-side inductor, a three-phase rectifier leg and the common-mode suppression circuit, causing a certain loss.

The Chinese patent CN116686201A discloses a discontinuous pulse width modulation method and a three-phase inverter modulation circuit. In this patent, three-phase AC voltages are compared in magnitude to give the maximum and minimum phase voltages, based on which a zero-sequence component is obtained, and a coefficient “k” is introduced to adjust the zero-sequence component. This patent proposes a simplification way to realize a DPWM modulation strategy, which retains high efficiency of DPWM modulation methods. In this patent, the zero-sequence component is calculated from the three-phase AC voltage, so it can be regarded as a fixed value, but a modulation signal needs to be calculated via a loop, so it is difficult to realize the DPWM modulation strategy when a fluctuation occurs to the loop.

The Chinese patent CN116827157A discloses a photovoltaic grid-connected inverter system and a control method based on discontinuous modulation. In this patent, a multi-level inverter gets optimized for multiple targets by setting up a square wave signal, an intersection point between a square wave and a three-phase sinusoidal modulation signal is used to divide a clamping interval; and it is possible to compensate a common-mode current and balance a mid-point potential by adjusting a pulse width and an amplitude of the square wave signal, so the way to achieve them is relatively simple. In this patent, it is impossible to concurrently compensate the common-mode current and balance the mid-point potential, so it is necessary to preset a priority level to optimize one of the targets. In addition, the compensation of the common-mode current depends on a common-mode current loop, that is, a serious hysteresis exists in the compensation and it is only able to compensate the DC component of the common-mode current, resulting in an unsatisfactory compensation effect.

The Chinese patent CN115566918A discloses a three-level inverter and a discontinuous pulse width modulation method and a device thereof. In this patent, a variety of vector combinations are given by making a clamping control and a common-mode voltage control with the aid of a three-phase modulation voltage and an initial minimum three-phase modulation voltage, and then an optimal vector combination is selected in accordance with a minimum midline current, so as to achieve an effective control to the mid-point potential.

In this patent, it is necessary to store a variety of vector combinations in a controller, causing a large amount of occupation on the controller memory; it is needed to frequently calculate the minimum midline current to select the optimal vector combination, slowing down a software running speed. In addition, it is inevitable to frequently switch the modulation strategies, resulting in severe distortion of a three-phase AC-side current.

### SUMMARY OF THE INVENTION

In view of the problems existing in the prior art, the present invention provides a phase-shift discontinuous pulse-width modulation method and a three-phase converter.

The technical scheme of the present invention is to design a phase-shift discontinuous pulse-width modulation method, including the step of: enabling a switching element of an one-phase leg unit to keep switched on or switched off in any switching cycle, and enabling a phase shift ratio ΔΦ to occur between driving signals of switching elements of the other two one-phase leg units, during operation of a three-phase converter, so that an upper-leg switching element of each one-phase leg unit in a three-phase leg assembly is asynchronously switched on or switched off at any time-point.

Further, the step of enabling a switching element of an one-phase leg unit to keep switched on or switched off in any switching cycle, and enabling a phase shift ratio ΔΦ to occur between driving signals of switching elements of the other two one-phase leg units includes: in the case that a modulation signal of the switching element of the one-phase leg unit in the three-phase converter is clamped to a peak value of a carrier wave, setting at most one one-phase driving signal of upper-leg switching elements of the other two one-phase leg units at any time-point to be a high level; in the case that a modulation signal of the switching element of the one-phase leg unit in the three-phase converter is clamped to a valley value of a carrier wave, setting at least one one-phase driving signal of upper-leg switching elements of the other two one-phase leg units at any time-point to be a high level.

Further, the step of enabling a switching element of an one-phase leg unit to keep switched on or switched off in any switching cycle, and enabling a phase shift ratio ΔΦ to occur between driving signals of switching elements of the other two one-phase leg units further includes:
a first modulation strategy: enabling the switching element of the one-phase leg unit in the three-phase converter to keep switched on or switched off; among the other two one-phase leg units, setting a high level middle time-point of a driving signal of an upper-leg switching element of the leg unit with a high phase voltage to be Φ₁Tₛ, while setting a high level middle time-point of a driving signal of an upper-leg switching element of the leg unit with a low phase voltage to be Φ₂Tₛ; and
a second modulation strategy: enabling the switching element of the one-phase leg unit in the three-phase converter to keep switched on or switched off; among the other two one-phase leg units, setting a high level middle time-point of a driving signal of an upper-leg switching element of the leg unit with a low phase voltage to be Φ₁Tₛ, while setting a high level middle time-point of a driving signal of an upper-leg switching element of the leg unit with a high phase voltage to be Φ₂Tₛ,
where, Ts represents a cycle of the driving signal, ΔΦ=Φ₂−Φ₁, and Φ₂>Φ₁.

Further, an AC cycle of the three-phase converter is divided into 3Z clamping intervals, and each of the clamping intervals has at least one the switching cycle, a clamping interval where any phase modulation signal is clamped to a peak value of a carrier wave or a valley value of a carrier wave is a clamping interval of a phase corresponding to the modulation signal;
where, Z is a positive integer.

Further, a switching time-point between any two of the adjacent clamping intervals is set as a start time-point or an end time point of a switching cycle of the driving signal.

Further, in a clamping interval where any one of the one-phase modulation signals ascends and descends, positions of high level middle time-points of a driving signal of an upper-leg switching element of a leg unit corresponding to the modulation signal differ from each other, so that an upper-leg switching element of each one-phase leg unit in a three-phase leg assembly is asynchronously switched on or switched off at any time-point.

Further, the phase-shift discontinuous pulse-width modulation method, including: any one-phase modulation signal is optional to change the positions of the high level middle time-points of the driving signal of the phase leg unit corresponding to the modulation signal at the time of entering the clamping interval of the phase corresponding to the modulation signal, exiting the clamping interval of the phase corresponding to the modulation signal, or lying in the clamping interval of the phase corresponding to the modulation signal.

Further, the phase-shift discontinuous pulse-width modulation method, including: the AC cycle of the three-phase converter is divided into 6 clamping intervals, and switching time-points of the 6 clamping intervals are set as t₁, t₂, t₃, t₄, t₅ and to in turn;

an A-phase modulation signal of the three-phase converter is set to change the high level middle time-points of the upper-leg switching element at t₁, t₃, t₄, and t₆, a B-phase modulation signal of the three-phase converter is set to change the high level middle time-points of the upper-leg switching element at t₂, t₃, t₅, and t₆, a C-phase modulation signal of the three-phase converter is set to change the high level middle time-points of the upper-leg switching element at t₁, t₂, t₄, and t₅.

Further, the AC cycle of the three-phase converter is divided into 12 clamping intervals, and switching time-points of the 12 clamping intervals are set as t₀, t₁, t₂, t₃, t₄, t₅, t₆, t₇, t₈, t₉, t₁₀ and t₁₁ in turn, when the three-phase converter executes the first modulation strategy, an A-phase modulation signal of the three-phase converter is set to change the high level middle time-points of the upper-leg switching element at t₀, t₁, t₅, t₆, t₇ and t₁₁, a B-phase modulation signal of the three-phase converter is set to change the high level middle time-points of the upper-leg switching element at t₃, t₄, t₅, t₉, t₁₀ and t₁₁, a C-phase modulation signal of the three-phase converter is set to change the high level middle time-points of the upper-leg switching element at t₁, t₂, t₃, t₇, t₈ and t₉.

The present invention further provides a three-phase converter that adopts the phase shift discontinuous pulse width modulation method above-mentioned, including: an A-phase leg unit, a B-phase leg unit, and a C-phase leg unit; wherein among the A-phase leg unit, the B-phase leg unit, and the C-phase leg unit, there is a switching element of an one-phase leg unit that keeps switched on or switched off in any switching cycle, and a phase shift ratio ΔΦ that occurs between driving signals of switching elements of the other two one-phase leg units, so that an upper-leg switching element of each one-phase leg unit in a three-phase leg assembly is asynchronously switched on or switched off at any time-point.

Compared with the prior art, the present invention has at least the following beneficial effects.

By way of enabling a switching element of an one-phase leg unit to keep switched on or switched off in any switching cycle, and enabling a phase shift ratio ΔΦ to occur between driving signals of switching elements of the other two one-phase leg units, so that an upper-leg switching element of each one-phase leg unit in a three-phase leg assembly is asynchronously switched on or switched off at any time-point, it is possible for the phase-shift discontinuous pulse-width modulation method proposed by the present invention to reduce the common-mode voltage and the common-mode current between the mid-point M of the DC-side capacitor and the neutral point N of the AC-side filter capacitor, and abate the overall loss of the three-phase converter to a certain extent. In addition, adopting the phase-shift discontinuous pulse-width modulation method proposed by the present invention makes it possible to omit an isolation circuit that is additionally used for the existing DPWM modulation, and uniformly use the mid-point of the DC-side capacitor or the neutral point of the AC-side filter capacitor as a reference ground of the sampling circuit.

That is, the phase-shift discontinuous pulse-width modulation method proposed by the present invention optimizes the efficiency of the three-phase converter on the basis of simplifying design of the sampling circuit and optimizing costs.

### BRIEF DESCRIPTION OF THE DRAWINGS

In order to explain the technical solutions in the embodiments of the present invention or the prior art more clearly, the drawings needing to be used in the descriptions of the embodiments or the prior art are briefly introduced hereinafter. Obviously, the drawings in the following descriptions are only exemplary, and for those of ordinary skills in the art, other drawings may also be derived and obtained based on the provided drawings without going through any creative work.

FIG. 1 schematically shows a topology of the three-phase converter circuit.

FIG. 2 schematically shows a topology of the three-phase converter circuit with a common-mode suppression circuit.

FIGS. 3A˜3F is a schematic diagram of the existing six DPWM modulation strategies.

FIG. 4 schematically shows a 6-interval division mode for the PSDPWM modulation strategy of the present invention.

FIGS. 5A˜5F schematically shows PWM timing sequences of the DPWM1, PSDPWM_1 and PSDPWM_2 modulation strategies within the R1 and R2 intervals.

FIG. 6 schematically shows a topology of the three-phase voltage source rectifier.

FIGS. 7A˜7C is a schematic diagram of the common-mode voltages V_{MN} of the DPWM1 modulation strategy in one switching cycle within the X1 interval and the proposed PSDPWM modulation strategy.

FIGS. 8A˜8D is a simulation waveform of the PSDPWM modulation strategy.

FIG. 9 shows PWM timing sequences of the PSDPWM_SS1 modulation strategy within the intervals from X1 to X3.

FIG. 10 shows PWM timing sequences of the PSDPWM_SS2 modulation strategy within the intervals from X1 to X3.

FIGS. 11A˜11B shows simulation results of the PSDPWM_1 and PSDPWM_SS1 6-interval modulation strategies at the time of updating intervals in a switching cycle.

FIG. 12 shows a simulation result of the PSDPWM_1 6-interval modulation strategy at the time of updating intervals at a start time-point or an end time-point of a switching cycle.

FIG. 13 schematically shows a 12-interval division mode for the PSDPWM modulation strategy of the present invention.

FIG. 14 shows PWM timing sequences of the PSDPWM_TS1 modulation strategy within the intervals from S1 to S6.

FIG. 15 shows PWM timing sequences of the PSDPWM_TS2 modulation strategy within the intervals from S1 to S6.

FIGS. 16A˜16B shows simulation results of the PSDPWM_1 and PSDPWM_TS1 12-interval modulation strategies at the time of updating intervals in a switching cycle.

FIG. 17 shows a simulation result of the PSDPWM_1 12-interval modulation strategy at the time of updating intervals at a start time-point or an end time-point of a switching cycle.

FIG. 18 shows control logic of the present invention in its entirety.

### DETAILED DESCRIPTION OF SOME EMBODIMENTS

In order to make the technical problem, technical solution and beneficial effect to be solved by the present invention more clearly understood, we shall further describe the present invention in detail in combination with the drawings and examples as follows. It should be understood that the specific examples described herein are only used to explain the present invention, not to pose a limitation on the present invention.

Therefore, occurrence of a technical feature in one example herein does not imply that all examples involved in the present invention must have this technical feature. Although some technical features can be combined to illustrate possible system designs, they can also be used in other combinations that are not explicitly stated. Unless otherwise specified, the combination of technical features in the examples is not intended to pose a limitation on the present invention.

We shall describe the principle and structure of the present invention in detail in combination with the drawings and examples as follows.

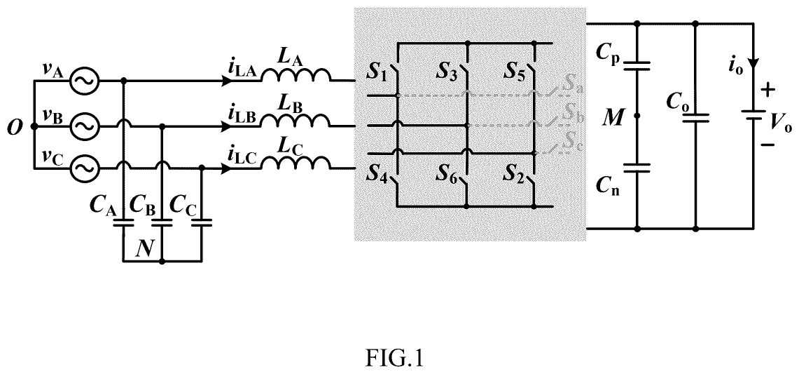

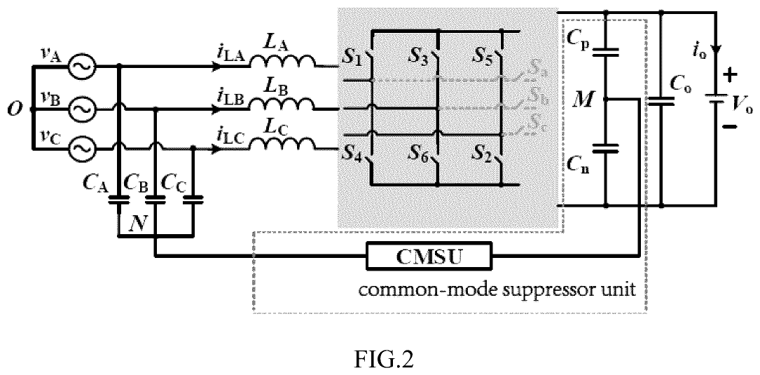

In the prior art, a three-phase converter topology may be simplified as FIG. 1. In the case of adopting the existing DPWM modulation strategy, a common-mode voltage with a large amplitude occurs between a mid-point M of a DC-side capacitor and a neutral point N of an AC-side filter capacitor, making it necessary to isolate a DC-side sampling circuit from an AC-side sampling circuit by means of an isolation circuit, so as to make a hardware circuit operate safely and stably. Additional costs arising from the isolation circuit undoubtedly limit the application of the DPWM modulation technology in three-phase converters.

It is possible for the phase-shift discontinuous pulse-width modulation method proposed by the present invention to reduce a voltage at both ends of the common-mode suppressor unit and a current via the ends by controlling a phase shift ratio ΔΦ, so as to achieve the purpose of optimizing the efficiency of the three-phase converter on the basis of simplifying a design for the sampling circuit and optimizing costs. The common-mode suppressor unit may be composed of components such as capacitors, inductors, resistors, or even a conducting wire.

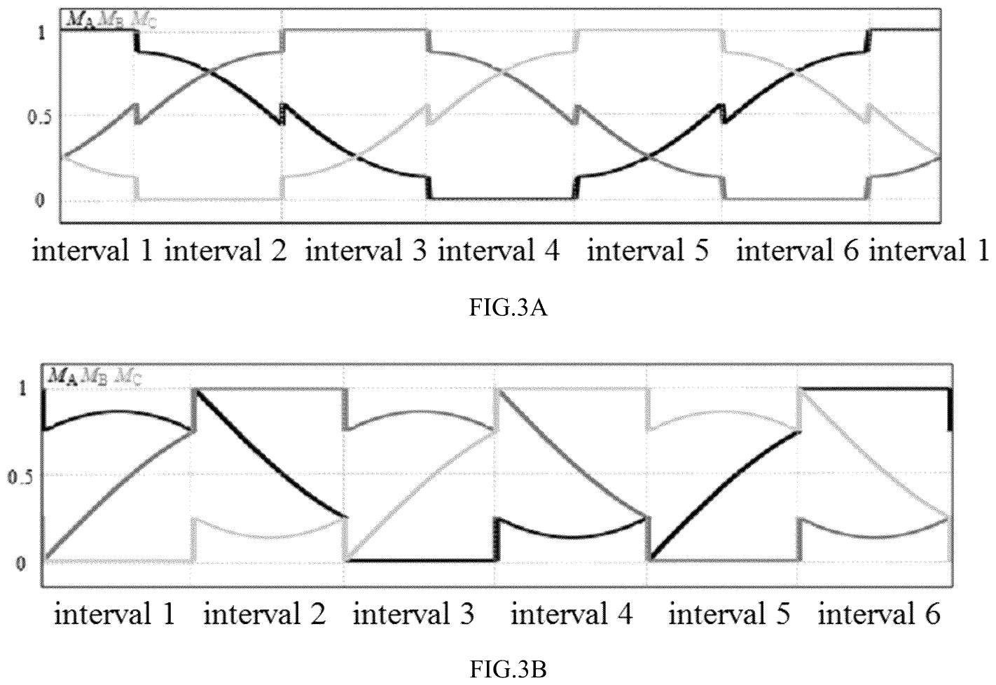

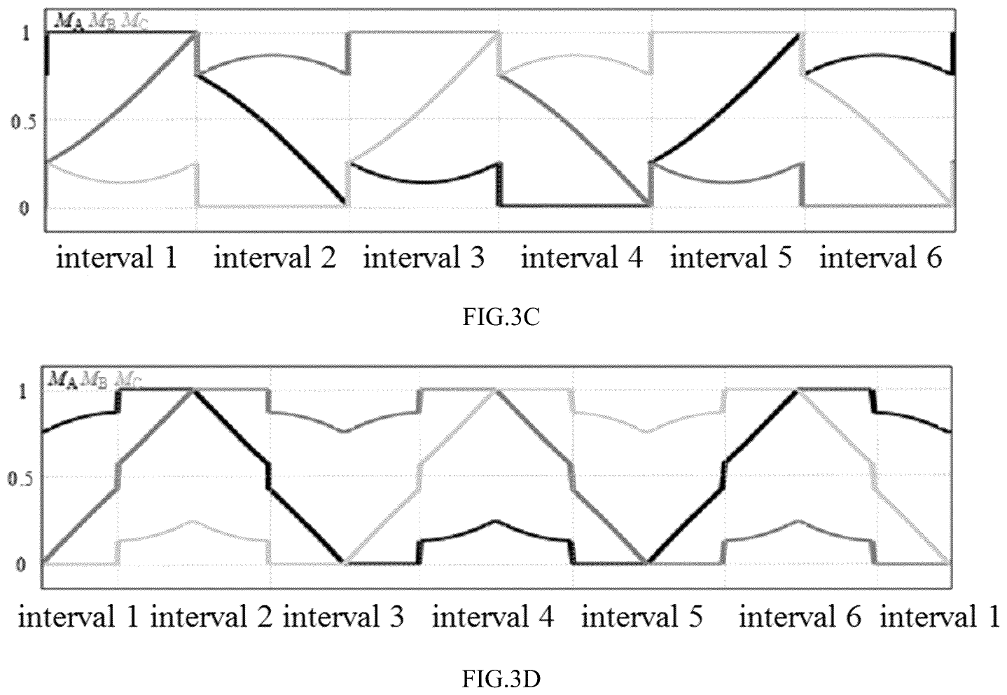

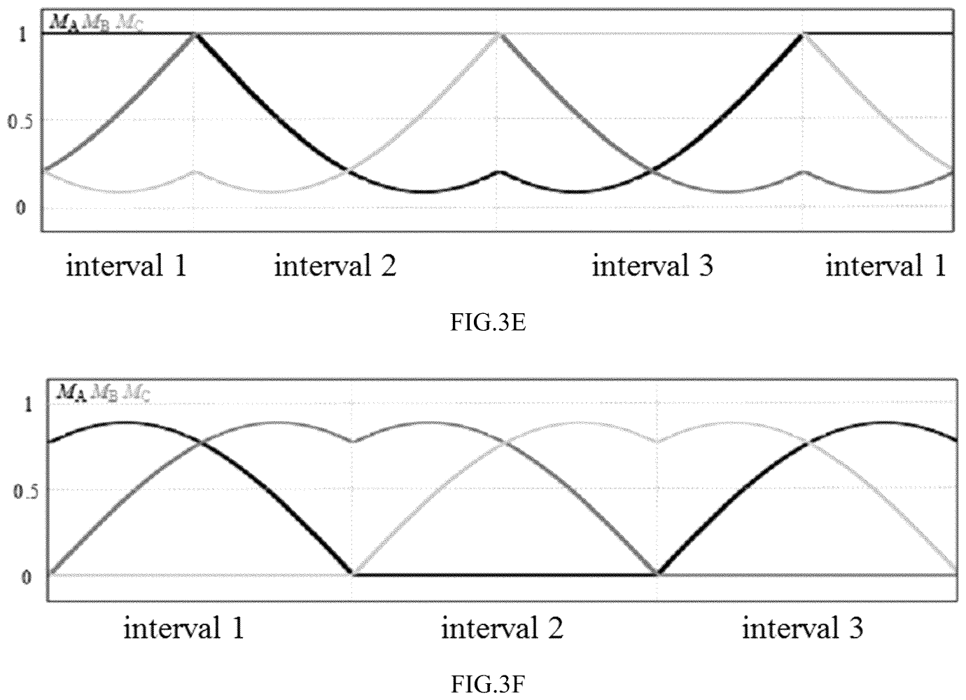

FIGS. 3A˜3F respectively enumerates six existing DPWM modulation strategies, and the improvement method for the phase shift discontinuous pulse width modulation method proposed by the present invention is not limited to these six existing DPWM modulation strategies. The DPWM1 modulation strategy shown in FIGS. 3A˜3F is taken as an example, elaborating a specific implementing measure and a theoretical deduction about the improvement method of the proposed modulation strategy as follows.

Specifically, a phase-shift discontinuous pulse-width modulation method proposed by the present invention includes:

enabling a switching element of an one-phase leg unit to keep switched on or switched off in any switching cycle, and enabling a phase shift ratio ΔΦ to occur between driving signals of switching elements of the other two one-phase leg units, during operation of a three-phase converter, so that an upper-leg switching element of each one-phase leg unit in a three-phase leg assembly is asynchronously switched on or switched off at any time-point.

The three-phase converter referred to herein may be a three-phase AC/DC converter or a three-phase DC/AC converter, which are all applicable to the design idea of the present invention, not subjected any limitation from the present invention.

In the present invention, it is possible to obviously reduce a voltage at both ends of the common-mode suppressor unit and a current via the ends by controlling a phase shift ratio ΔΦ, so as to achieve the purpose of optimizing the efficiency of the three-phase converter on the basis of simplifying a design for the sampling circuit and optimizing costs.

The modulation strategy proposed herein by the present invention includes a first modulation strategy (hereinafter referred to as a PSDPWM_1 modulation strategy) and a second modulation strategy (hereinafter referred to as a PSDPWM_2 modulation strategy).

In the above solution, as for the phase shift ratio ΔΦ, if the switching element of the one-phase leg unit keeps switched on or switched off in any switching cycle, determining phase positions of the driving signals of the switching elements of the other two one-phase leg units corresponds to determining the phase shift ratio ΔΦ, thus it is possible to obviously reduce the voltage at both ends of the common-mode suppressor unit and the current via the ends by rationally selecting the phase shift ratio ΔΦ.

Specially, in the present invention, in the case that the switching element of the one-phase leg unit keeps switched on or switched off in any switching cycle, and the phase shift ratio ΔΦ occurs between the driving signals of the switching elements of the other two one-phase leg units, the two modulation strategies involved in that case are as follows.

A first modulation strategy: the switching element of the one-phase leg unit in the three-phase converter keeps switched on or switched off; among the other two one-phase leg units, a high level middle time-point of the driving signal of the upper-leg switching element of the leg unit with a high phase voltage is Φ₁Tₛ, while a high level middle time-point of the driving signal of the upper-leg switching element of the leg unit with a low phase voltage is Φ₂Tₛ.

A second modulation strategy: the switching element of the one-phase leg unit in the three-phase converter keeps switched on or switched off; among the other two one-phase leg units, a high level middle time-point of the driving signal of the upper-leg switching element of the leg unit with a low phase voltage is Φ₁Tₛ, while a high level middle time-point of the driving signal of the upper-leg switching element of the leg unit with a high phase voltage is Φ₂Tₛ.

Where, Ts represents a cycle of a modulation signal, ΔΦ=Φ₂−Φ₁, and Φ₂>Φ₁.

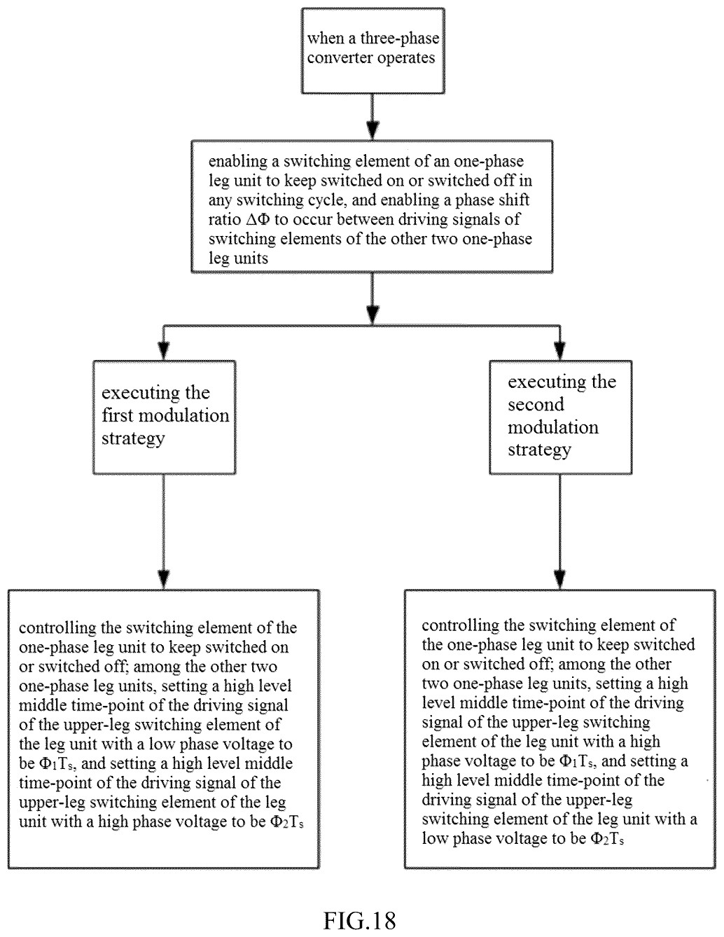

Referring to FIG. 18, the control logic of the present invention in its entirety consists in controlling a switching element of an one-phase leg unit to keep switched on or switched off in any switching cycle, and enabling a phase shift ratio ΔΦ to occur between driving signals of the switching elements of the other two one-phase leg units, during operation of a three-phase converter;
as a first modulation strategy, controlling the switching element of the one-phase leg unit in the three-phase converter to keep switched on or switched off; among the other two one-phase leg units, setting a high level middle time-point of the driving signal of the upper-leg switching element of the leg unit with a high phase voltage to be Φ₁Tₛ, and setting a high level middle time-point of the driving signal of the upper-leg switching element of the leg unit with a low phase voltage to be Φ₂Tₛ;
as a second modulation strategy, controlling the switching element of the one-phase leg unit in the three-phase converter to keep switched on or switched off; among the other two one-phase leg units, setting a high level middle time-point of the driving signal of the upper-leg switching element of the leg unit with a low phase voltage to be Φ₁Tₛ, and setting a high level middle time-point of the driving signal of the upper-leg switching element of the leg unit with a high phase voltage to be Φ₂Tₛ.

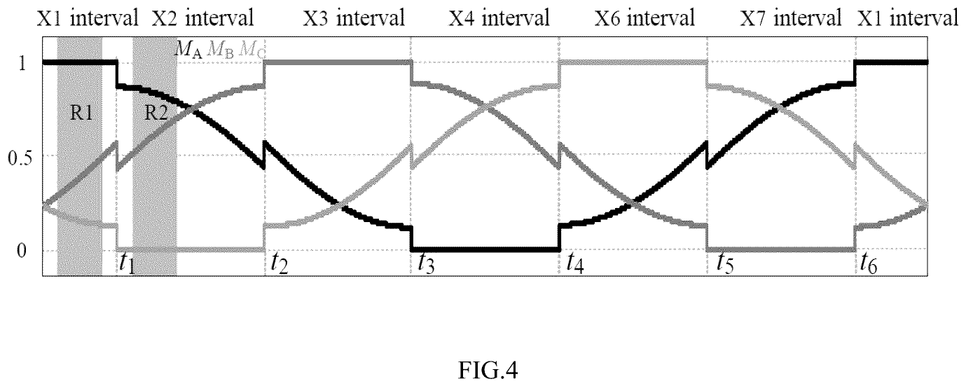

As shown in FIG. 4, a variety of clamping modes for the DPWM1 modulation strategy have been given in the existing literature, mainly including a clamping mode based on sector division and a clamping mode of introducing a zero-sequence component. The so-called clamping refers to the fact that a switching tube of a phase leg unit does not act, and a modulation signal for this phase leg unit is clamped to a peak value of a carrier wave or a valley value of a carrier wave.

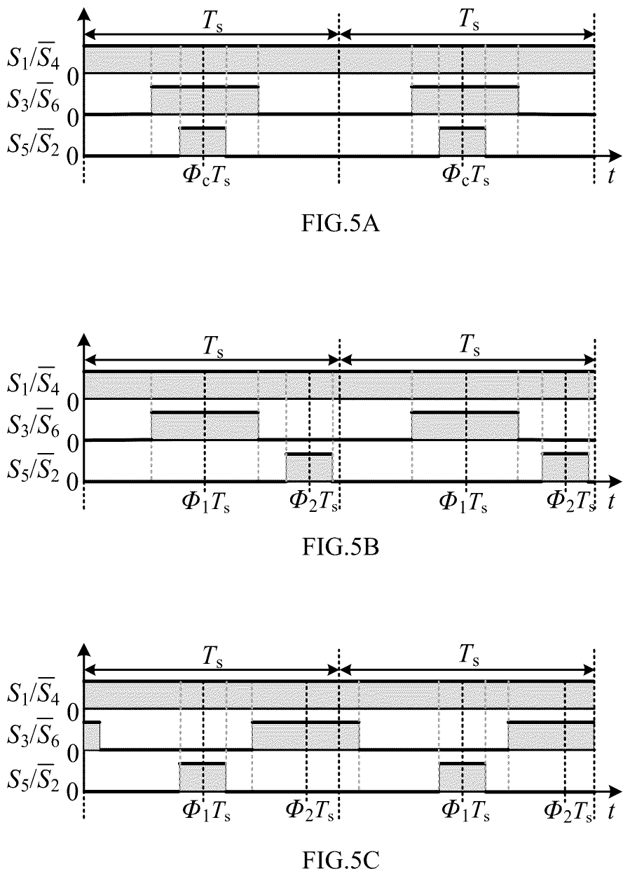

Taking the zones R1 and R2 in FIG. 4 as an example, the PWM time-sequence diagrams of the proposed two modulation strategies are shown in FIGS. 5A˜5F. FIGS. 5A and 5D shows a PWM time-sequence diagram of the DPWM1 modulation strategy in the zones R1 and R2, respectively. In a switching cycle, equivalent upper and lower switches of an A-phase leg unit do not act, and high level middle time-points of driving signals of equivalent upper switches of B and C phase leg units are all Φ_{c}Tₛ, usually Φ_{c}=0.5.

FIGS. 5B and 5C shows the PWM time-sequence diagram of the two PSDPWM modulation strategies occurring in the R1 zone, respectively.

As shown in FIG. 5B, the PWM time-sequence of the PSDPWM_1 modulation strategy in a switching cycle is as follows. Equivalent upper and lower switches (S₁ and S₄) of an A-phase leg unit do not act, a high level middle time-point of a driving signal of an equivalent upper switch (S₃) of a B-phase leg unit is Φ₁Tₛ, a high level middle time-point of a driving signal of an equivalent upper switch (S₅) of a C-phase leg unit is Φ₂Tₛ.

The equivalent upper and lower switches (S₁ and S₄) of the A-phase leg unit herein is the switching element of the one-phase leg unit, that does not act, described above.

The equivalent upper switch (S₃) of the B-phase leg unit herein is the upper-leg switching element of the leg unit with a high phase voltage, described above.

The equivalent upper switch (S₅) of the C-phase leg unit herein is the upper-leg switching element of the leg unit with a low phase voltage, described above.

Φ₁ and Φ₂ both presents a phase position, and the phase shift ΔΦ described above is a difference between Φ₁ and Φ₂, which are set to be Φ₂>Φ₁ herein.

As shown in FIG. 5C, the PWM time-sequence of the PSDPWM_2 modulation strategy in a switching cycle is as follows. Equivalent upper and lower switches (S₁ and S₄) of an A-phase leg unit do not act, a high level middle time-point of a driving signal of an equivalent upper switch (S₅) of a C-phase leg unit is Φ₁Tₛ, a high level middle time-point of a driving signal of an equivalent upper switch (S₃) of a B-phase leg unit is Φ₂Tₛ.

The equivalent upper and lower switches (S₁ and S₄) of the A-phase leg unit herein is the switching element of the one-phase leg unit, that does not act, described above.

The equivalent upper switch (S₃) of the B-phase leg unit herein is the upper-leg switching element of the leg unit with a high phase voltage, described above.

The equivalent upper switch (Ss) of the C-phase leg unit herein is the upper-leg switching element of the leg unit with a low phase voltage, described above.

Φ₁ and Φ₂ both presents a phase position, and the phase shift ΔΦ described above is a difference between Φ₁ and Φ₂, which are set to be Φ₂>Φ₁ herein.

Further, based on the above control logic, the step of enabling a switching element of an one-phase leg unit to keep switched on or switched off in any switching cycle, and enabling a phase shift ratio ΔΦ to occur between driving signals of switching elements of the other two one-phase leg units, includes:
in the case that a modulation signal of the switching element of the one-phase leg unit in the three-phase converter is clamped to a peak value of a carrier wave, setting at most one one-phase driving signal of upper-leg switching elements of the other two one-phase leg units at any time-point to be a high level; in the case that a modulation signal of the switching element of the one-phase leg unit in the three-phase converter is clamped to a valley value of a carrier wave, setting at least one one-phase driving signal of upper-leg switching elements of the other two one-phase leg units at any time-point to be a high level.

In the above-mentioned control logic, the driving signals of the switching elements of the upper and lower legs of any phase leg unit in the three-phase converter are complementary, and when the switching elements of the upper-leg and the lower leg of an identical leg unit execute state switching, a dead time is set.

It is aimed to avoid the upper and lower equivalent switching elements from being switched on concurrently during the delay time when the switching element is switched on and switched off, resulting in short-circuit faults of capacitors.

As for the driving signal of the remaining two-phase upper equivalent switching element, the PSDPWM_1 modulation strategy is defined as: setting the high level middle time-point of the upper-leg switching element of the leg unit with a high phase voltage to be Φ₁Tₛ, and setting the high level middle time-point of the upper-leg switching element of the leg unit with a low phase voltage to be Φ₂Tₛ, and ΔΦ=Φ₂−Φ₁>0. Otherwise, it is the PSDPWM_2 modulation strategy.

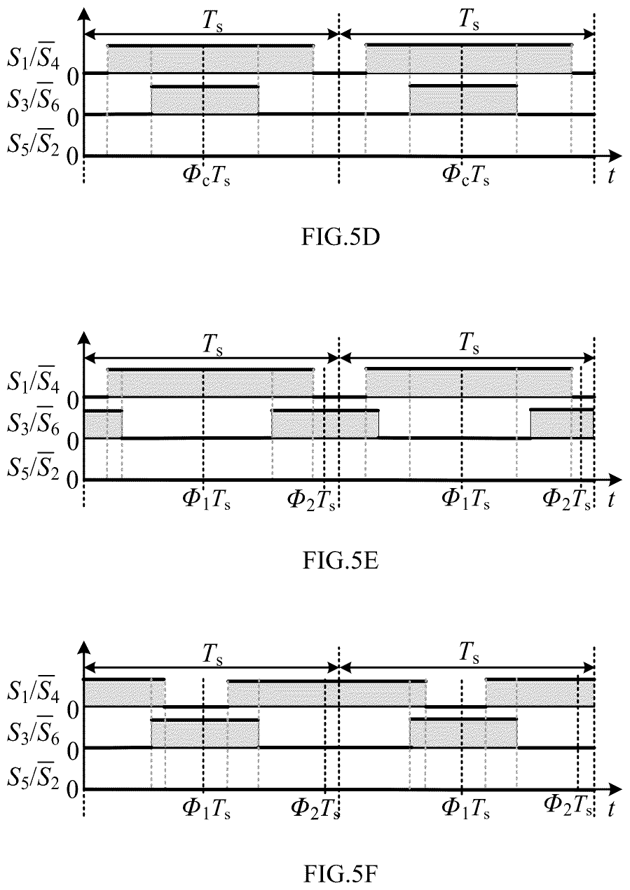

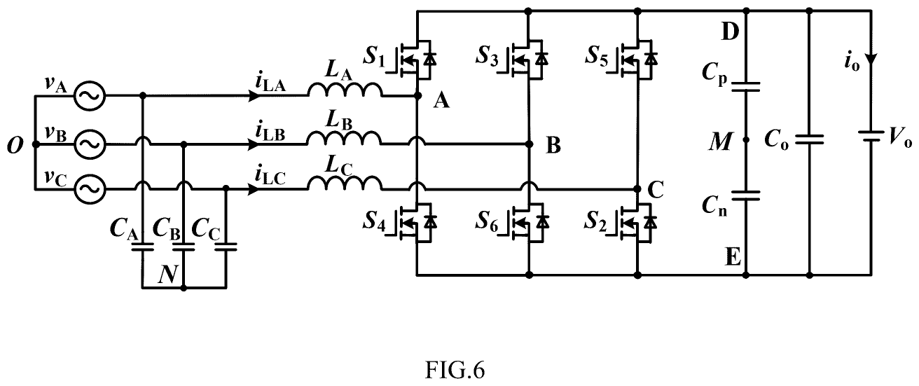

Referring to FIG. 6, taking a three-phase voltage source rectifier as an example, we shall theoretically deduce the common-mode voltage V_{MN} of the DPWM1 and the PSDPWM_1 modulation strategies.

To simplify the analysis, an unipolar binary logic switching function Sₓ is defined for the three-phase voltage source rectifier as follows.

$${s}_{x} = \{ \begin{matrix}1 \\ 0\end{matrix} , x = A , B , C \qquad ( 1 )$$

Where, 1 denotes that an upper switching tube is switched on and a lower switching tube is switched off, and 0 denotes that an upper switching tube is switched off and a lower switching tube is switched on. According to the Kirchhoff's voltage law, voltage circuit equations for the three-phase voltage source rectifier is set up as follows:

$$\{ \begin{matrix}{v}_{LA} = L \frac{{di}_{LA}}{dt} = {v}_{A} - ( {v}_{AE} + {v}_{MN} - {v}_{ME} ) \\ {v}_{LB} = L \frac{{di}_{LB}}{dt} = {v}_{B} - ( {v}_{BE} + {v}_{MN} - {v}_{ME} ) \\ {v}_{LC} = L \frac{{di}_{LC}}{dt} = {v}_{C} - ( {v}_{CE} + {v}_{MN} - {v}_{ME} )\end{matrix} \qquad ( 2 )$$

Where, V_{xE}=SₓVₒ (x=A, B, C).

In consideration that the above equations are a three-phase symmetrical system, we can deduct the following equations.

$${v}_{A} + {v}_{B} + {v}_{C} = 0 , {i}_{A} + {i}_{B} + {i}_{C} = 0 \qquad ( 3 )$$

Simultaneously solving the equations (1), (2) and (3), we shall get the following result.

$${V}_{MN} = - \frac{{V}_{o}}{3} {\sum }_{x = A , B , C} {s}_{x} + {V}_{ME} \qquad ( 4 )$$

v_{ME} is a voltage at both ends of the capacitor Cn, in general, it is considered to be

$${v}_{ME} = {v}_{DM} = \frac{{V}_{o}}{2} .$$

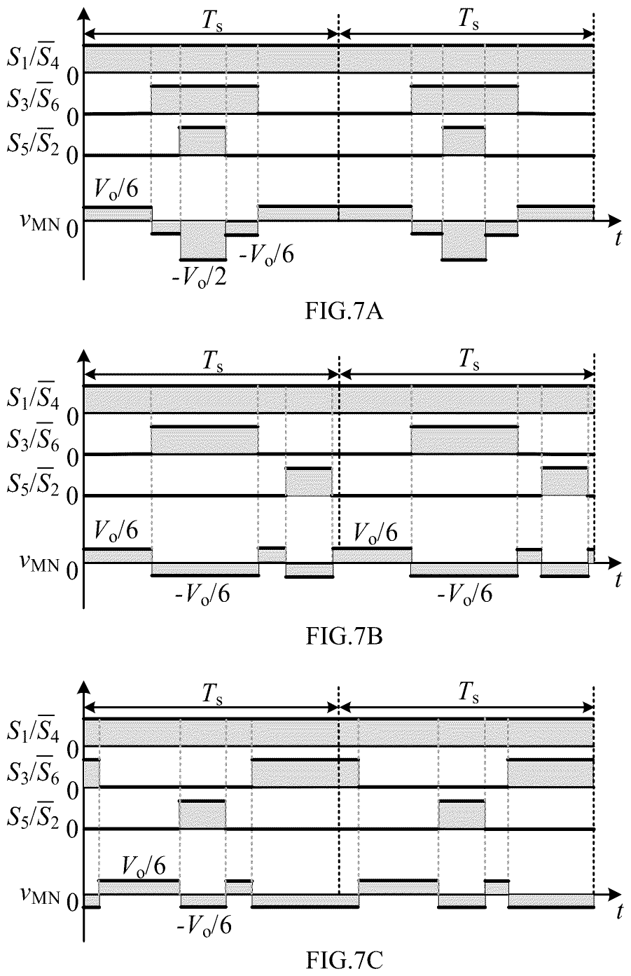

Therefore, a schematic diagram of the common-mode voltages V_{MN} for the DPWM1 modulation strategy and the proposed PSDPWM modulation strategy in a switching cycle is shown in FIGS. 7A˜7C. It can be seen from FIGS. 7A˜7C that the peak-to-peak values of the common-mode voltages V_{MN} of the PSDPWM_1 modulation strategy and the PSDPWM_2 modulation strategy are obviously lower than those of the DPWM1 modulation strategy.

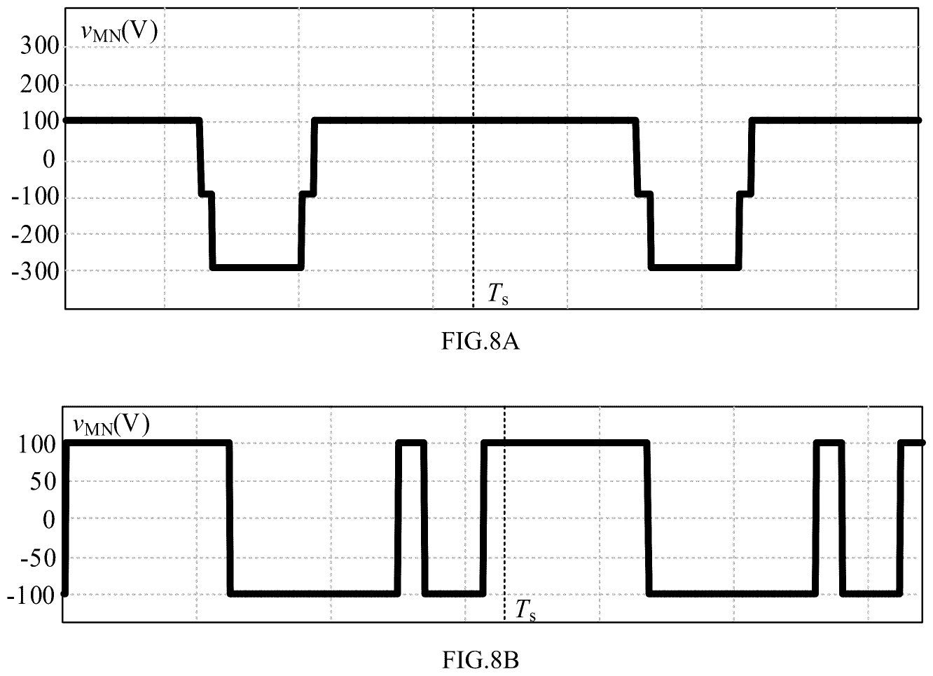

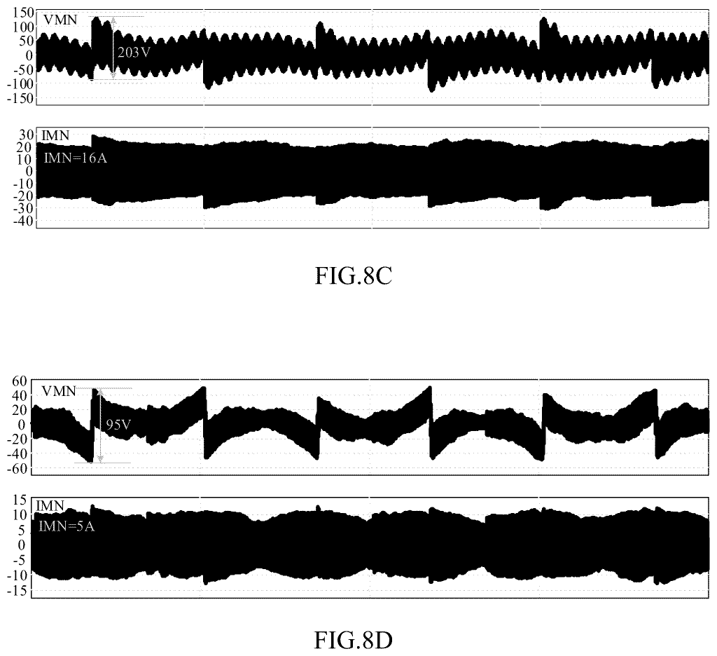

FIGS. 8A and 8B shows non-common-mode suppressor circuits with the common-mode voltages V_{MN} for the DPWM1 modulation strategy and the PSDPWM_1 modulation strategy at Vₒ=600V, respectively.

FIGS. 8C and 8D shows common-mode suppressor circuits (taking a CMSU composed by capacitors as an example) with simulation waveforms of the common-mode voltage V_{MN} and the common-mode current i_{MN} for the DPWM1 modulation strategy and the PSDPWM_1 modulation strategy at Vo=600V, respectively.

It can be seen from FIGS. 8A˜8D, the theoretical and simulation results of the DPWM1 modulation strategy and the PSDPWM_1 modulation strategy are completely consistent with each other in the non-common-mode suppressor circuits.

In the common-mode suppressor circuits, since the common-mode suppression unit is introduced, the peak-to-peak value of the common-mode voltage V_{MN} of the PSDPWM_1 modulation strategy obviously decreases; therefore, the peak-to-peak value of the common-mode voltage V_{MN} and the valid value of the common-mode current i_{MN} of the PSDPWM_1 modulation strategy are obviously lower those of the DPWM1 modulation strategy.

As the theoretical and simulation results of the PSDPWM_2 modulation strategy are similar to those of the PSDPWM_1 modulation strategy, so we shall not repeat them here.

Further, the aforementioned phase-shift discontinuous pulse-width modulation strategy includes: dividing an AC cycle of the three-phase converter into 6 clamping intervals, then setting switching time-points of the 6 clamping intervals as t₁, t₂, t₃, t₄, t₅ and t₆ in turn, making an A-phase modulation signal of the three-phase converter exit the clamping intervals at t₁ and t₄ and enter the clamping intervals at t₃ and t₆, making a B-phase modulation signal of the three-phase converter exit the clamping intervals at t₃ and t₆ and enter the clamping intervals at t₅ and t₂, making a C-phase modulation signal of the three-phase converter exit the clamping intervals at t₅ and t₂ and enter the clamping intervals at t₁ and t₄;
enabling the A-phase modulation signal of the three-phase converter to change the high level middle time-points of the upper-leg switching element at t₁, t₃, t₄, and t₆, enabling the B-phase modulation signal of the three-phase converter to change the high level middle time-points of the upper-leg switching element at t₂, t₃, t₅, and t₆, enabling the C-phase modulation signal of the three-phase converter to change the high level middle time-points of the upper-leg switching element at t₁, t₂, t₄, and t₅.

As shown in FIG. 4, MA represents the waveform corresponding to the A phase modulation signal, MB represents the waveform corresponding to the B phase modulation signal, M_{C} represents the waveform corresponding to the C phase modulation signal.

In the present invention, the AC cycle of the three-phase converter is divided into 3Z clamping intervals, and each clamping interval has at least one switching cycle; where, Z is a positive integer.

In this example, Z is set as 2, thus the AC cycle of the three-phase converter is divided into 6 clamping intervals.

As shown in FIG. 4, the DPWM1 modulation strategy consists in dividing the AC cycle of the three-phase converter into six clamping intervals (X1˜X6). According to the aforementioned improvement method, the DPWM1 modulation strategy can be improved as the PSDPWM modulation strategy, but in order to reduce AC-side inductor current distortion, the modulation strategies of the adjacent intervals need to cooperate with each other to some extents.

An improvement method for the modulation strategy proposed by the present invention includes: in a clamping interval where any one-phase modulation signal ascends and descends, making the positions of the high level middle time-points of the driving signal of the upper-leg switching element of the leg unit corresponding to the modulation signal differ from each other, so that an upper-leg switching element of each one-phase leg unit in a three-phase leg assembly is asynchronously switched on or switched off at any time-point.

The improvement method for the modulation strategy proposed by the present invention further includes: making it possible for any one-phase modulation signal to optionally change the positions of the high level middle time-points of the driving signal of the phase leg unit corresponding to the modulation signal at the time of entering a clamping interval, exiting a clamping interval, or lying in a clamping interval.

Its detail is as follows.

Referring to FIG. 4, in the clamping interval where the modulation signal ascends and descends, the positions of the high level middle time-points of the driving signal of the upper-leg switching element of the leg unit corresponding to the modulation signal differ from each other, if in the clamping interval where the modulation signal ascends, the high level middle time-points of the driving signal of the upper-leg switching element of the leg unit corresponding to the modulation signal is Φ₁Tₛ, in the clamping interval where the modulation signal descends, the high level middle time-points of the driving signal of the upper-leg switching element of the leg unit corresponding to the modulation signal is Φ₂Tₛ, vice versa.

That is, the positions of the high level middle time-points of the driving signal of the upper-leg switching element of the A-phase leg unit within the intervals 2 and 3 differ from those within the intervals 5 and 6;
the positions of the high level middle time-points of the driving signal of the upper-leg switching element of the B-phase leg unit within the intervals 1 and 2 differ from those within the intervals 4 and 5;
the positions of the high level middle time-points of the driving signal of the upper-leg switching element of the C-phase leg unit within the intervals 3 and 4 differ from those within the intervals 1 and 6.

It is possible for any one-phase modulation signal to optionally change the positions of the high level middle time-points of the driving signal of the phase leg unit corresponding to the modulation signal at the time of entering a clamping interval of the phase corresponding to the modulation signal, exiting a clamping interval of the phase corresponding to the modulation signal, or lying in a clamping interval of the phase corresponding to the modulation signal.

Referring to FIG. 4, enabling the A-phase modulation signal of the three-phase converter to change the high level middle time-points of the upper-leg switching element at t₁, t₃, t₄, and t₆, enabling the B-phase modulation signal of the three-phase converter to change the high level middle time-points of the upper-leg switching element at t₂, t₃, t₅, and t₆, enabling the C-phase modulation signal of the three-phase converter to change the high level middle time-points of the upper-leg switching element at t₁, t₂, t₄, and t₅.

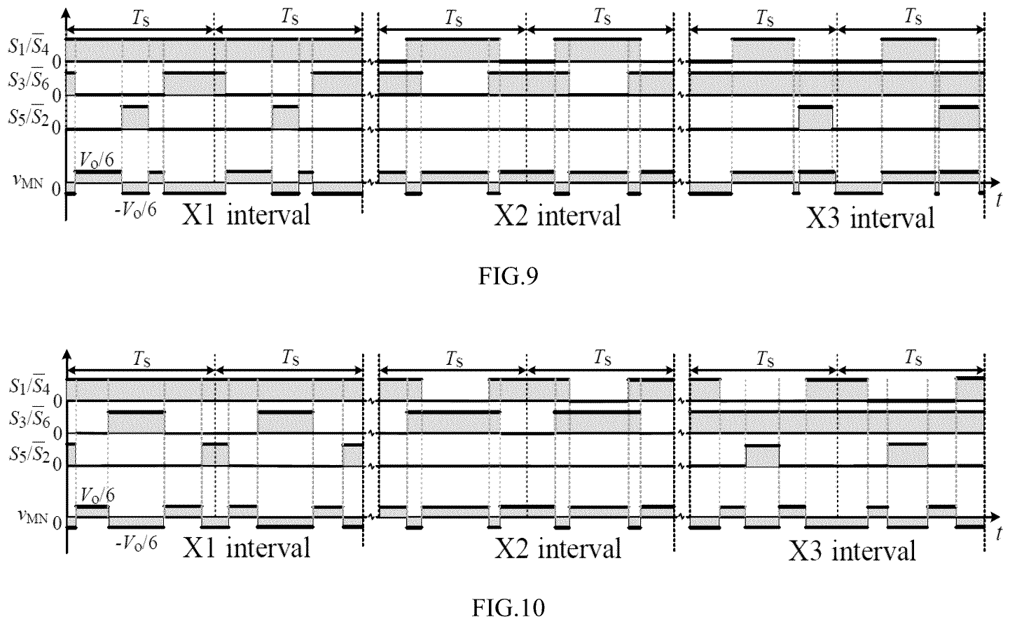

Based on the above idea, it is clear that there are multiple modulation strategies based on the 6 intervals in their entirety (hereinafter referred to as PSDPWM_SS modulation strategies) in an AC cycle. Two of these PSDPWM_SS modulation strategies (PSDPWM_SS1 and PSDPWM_SS2) are enumerated as follows, as shown in FIGS. 9 and 10.

FIG. 9 shows PWM timing sequences of the PSDPWM_SS1 modulation strategy within the intervals from X1 to X3; the PWM timing sequences in the rest of the intervals can be deduced out according to the improvement idea about the modulation mentioned above, so it is unnecessary to give a specific PWM timing sequence diagram herein.

FIG. 10 shows PWM timing sequences of the PSDPWM_SS2 modulation strategy within the intervals from X1 to X3; the PWM timing sequences in the rest of the intervals can be deduced out according to the improvement idea about the modulation mentioned above, so it is unnecessary to give a specific PWM timing sequence diagram herein.

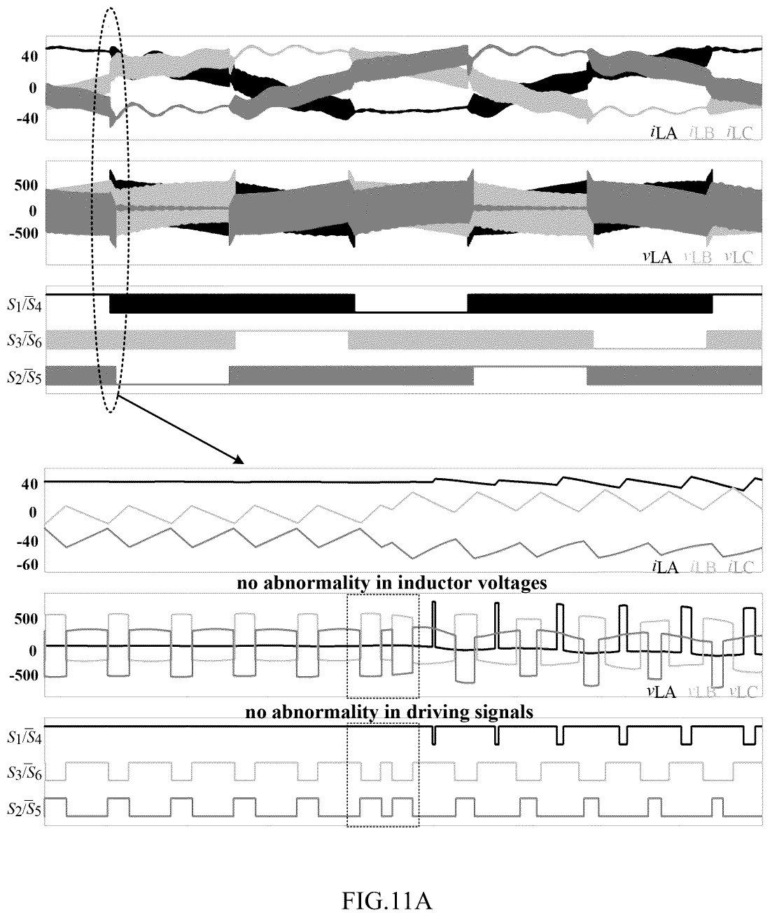

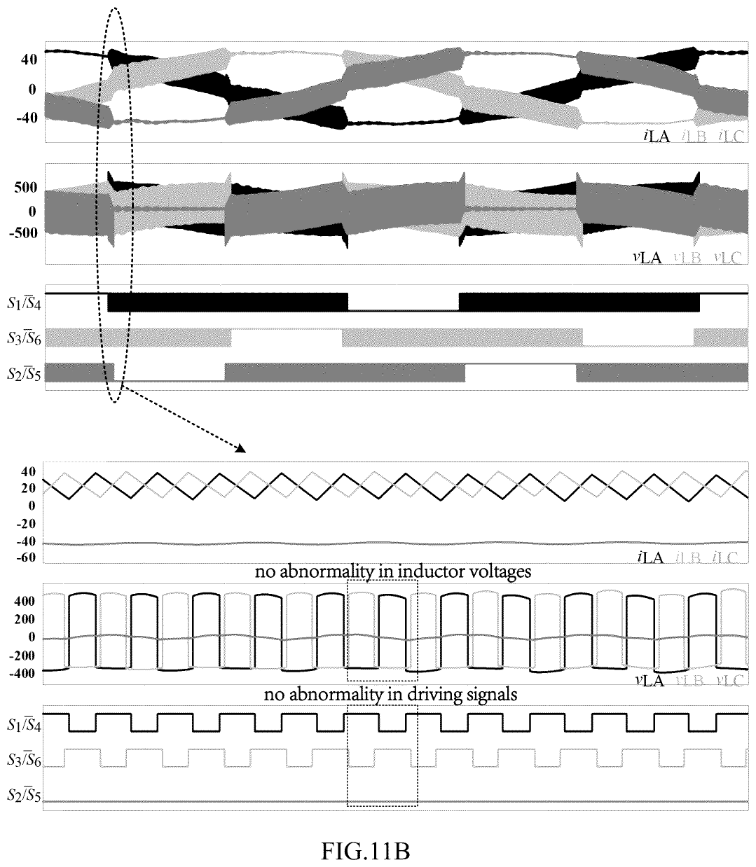

FIGS. 11A˜11B shows simulation results of the PSDPWM_1 and PSDPWM_SS1 6-interval modulation strategies at the time of updating intervals in a switching cycle. It can be seen from FIGS. 11A and 11B that the PSDPWM_SS1 modulation strategy eliminates the AC-side inductor current distortion at the time of switching intervals without changing the V_{MN} and i_{MN}.

In addition, the improvement method for the modulation strategy proposed by the present invention further includes: setting a switching time-point between any two adjacent clamping intervals as a start time-point or an end time point of the switching cycle of the driving signal.

Its detail is as follows.

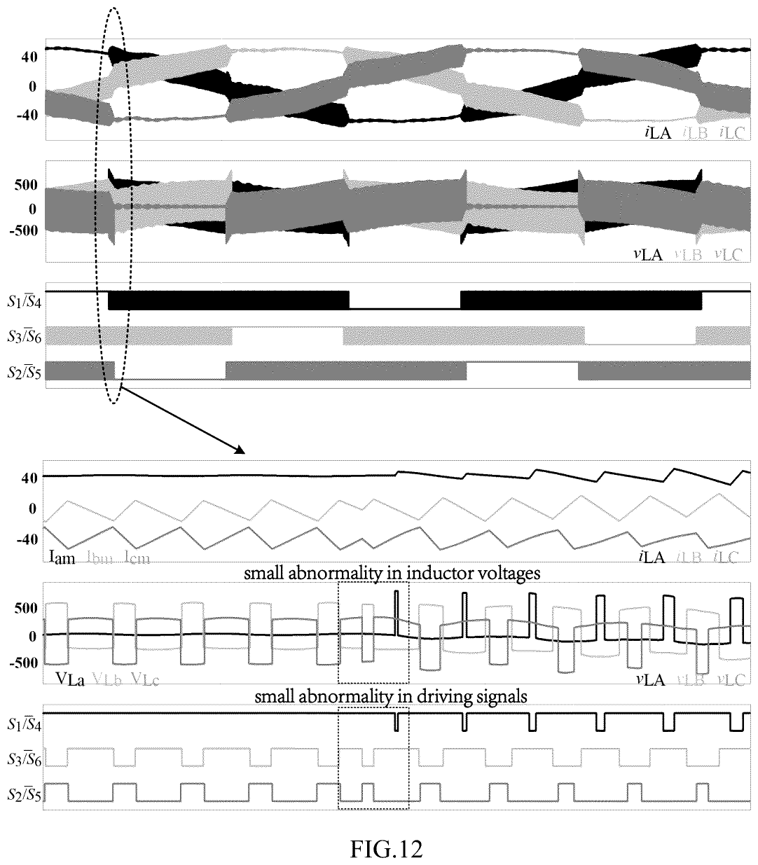

The cause of the AC-side inductor current distortion is that an abnormal AC-side inductor voltage leads to a volt-second product imbalance of the AC-side inductor in a short period of time, and the inductor current unidirectionally changes, generating distortion. For example, when the interval 1 is updated towards the interval 2, FIG. 12 shows a simulation result of the PSDPWM_1 6-interval modulation strategy at the time of updating intervals at a start time-point or an end time-point of a switching cycle.

It can be seen from FIG. 11A that an abnormality occurs to a B-phase inductor voltage at the time of switching, resulting in a volt-second product greater than 0 in a short period of time, and the inductor current increases rapidly, generating distortion.

It can be seen from FIG. 12 that an abnormality also occurs to a B-phase inductor voltage at the time of switching, but the volt-second product changes less obviously than that in FIG. 11A, so the inductor current distortion is not obvious.

Further, the aforementioned phase-shift discontinuous pulse width modulation strategy also includes: dividing an AC cycle of the three-phase converter into 12 clamping intervals, then setting switching time-points of the 12 clamping intervals as t₀, t₁, t₂, t₃, t₄, t₅, t₆, t₇, t₈, t₉, t₁₀ and t₁₁ in turn, making an A-phase modulation signal of the three-phase converter exit the clamping intervals at t₁ and t₇ and enter the clamping intervals at t₅ and t₁₁, making a B-phase modulation signal of the three-phase converter exit the clamping intervals at t₅ and t₁₁ and enter the clamping intervals at t₉ and t₃, making a C-phase modulation signal of the three-phase converter exit the clamping intervals at t₉ and t₃ and enter the clamping intervals at t₁ and t₇;
when the three-phase converter executes the first modulation strategy, enabling the A-phase modulation signal of the three-phase converter to change the high level middle time-points of the upper-leg switching element at t₀, t₁, t₅, t₆, t₇ and t₁₁, enabling the B-phase modulation signal of the three-phase converter to change the high level middle time-points of the upper-leg switching element at t₃, t₄, t₅, t₉, t₁₀ and t₁₁, enabling the C-phase modulation signal of the three-phase converter to change the high level middle time-points of the upper-leg switching element at t₁, t₂, t₃, t₇, t₈ and t₉.

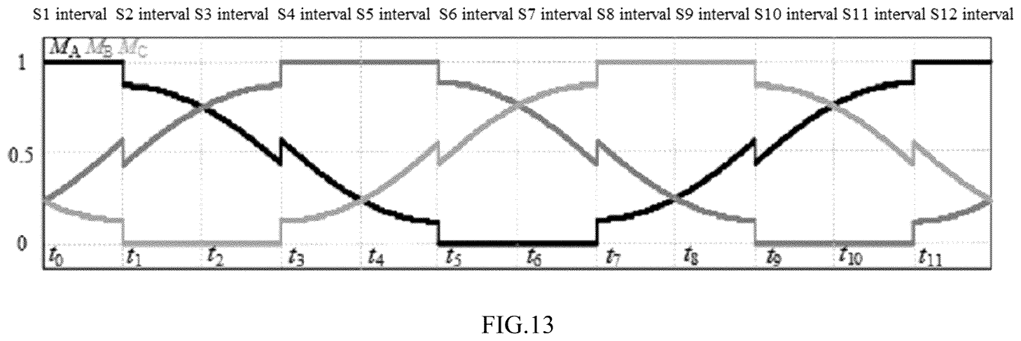

As shown in FIG. 13, MA represents the waveform corresponding to the A phase modulation signal, MB represents the waveform corresponding to the B phase modulation signal, M_{C} represents the waveform corresponding to the C phase modulation signal.

In the present invention, the AC cycle of the three-phase converter is divided into 3Z clamping intervals, and each clamping interval has at least one switching cycle; where, Z is a positive integer.

In this example, Z is set as 4, thus the AC cycle of the three-phase converter is divided into 12 clamping intervals.

FIG. 4 is divided into 12 intervals (S1˜S12) in an AC cycle, thus giving FIG. 13. According to the aforementioned improvement method, the DPWM1 modulation strategy can be improved as the PSDPWM modulation strategy, but in order to reduce AC-side inductor current distortion, the modulation strategies of the adjacent intervals need to cooperate with each other to some extents.

An improvement method for the modulation strategy proposed by the present invention includes: in a clamping interval where a modulation signal ascends and descends, making the positions of the high level middle time-points of the driving signal of the upper-leg switching element of any one-phase leg unit differ from each other;
and further includes: making it possible for any one-phase modulation signal to optionally change the positions of the high level middle time-points of the driving signal of the phase leg unit corresponding to the modulation signal at the time of entering a clamping interval, exiting a clamping interval, or lying in a clamping interval.

Its detail is as follows.

The idea of solving the AC-side inductor current distortion at the point of switching intervals for 12 intervals is similar to that for 6 intervals. The difference is that besides the possibility to change the positions of the high level middle time-points of the phase modulation signal, which enters a clamping interval or exits a clamping interval, it is also possible to change the positions of the high level middle time-points of the phase modulation signal, which switches from a clamping interval to another clamping interval.

That is, enabling the A-phase modulation signal of the three-phase converter to change the high level middle time-points of the upper-leg switching element at t₀, t₁, t₅, t₆, t₇ and t₁₁, enabling the B-phase modulation signal of the three-phase converter to change the high level middle time-points of the upper-leg switching element at t₃, t₄, t₅, t₉, t₁₀ and t₁₁, enabling the C-phase modulation signal of the three-phase converter to change the high level middle time-points of the upper-leg switching element at t₁, t₂, t₃, t₇, t₈ and t₉. In addition, the idea consistent with the improvement method for 6 intervals is that in order to ensure the implementation of the PSDWPM modulation strategy, the idea of making the positions of the high level middle time-points of the modulation signals differ from each other in a clamping interval where any phase modulation signal ascends and descends is consistent with that of the improvement method for 6 intervals, which will not be repeated herein, with reference to the above.

Taking the A-phase modulation signal as an example, if the A-phase modulation signal changes the high level middle time-points at t₁, t₅, t₇ and t₁₁, the improvement method for 12 intervals is equivalent that for 6 intervals, which will not be repeated herein; if the A-phase modulation signal changes the high level middle time-points at t₀ and t₆, there are two modulation strategies for the 12 intervals (hereinafter referred to as PSDPWM_TS1 and PSDPWM_TS2 modulation strategies) to eliminate the AC-side inductor current distortion at the point of switching intervals.

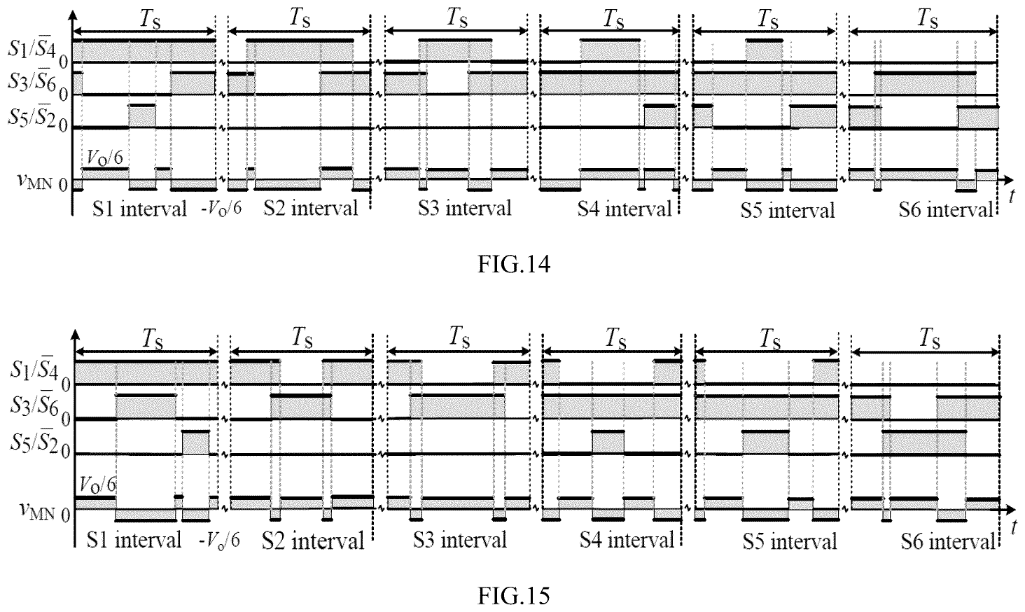

FIG. 14 shows PWM timing sequences of the PSDPWM_TS1 modulation strategy within the intervals from S1 to S6; the PWM timing sequences in the rest of the intervals can be deduced out according to the improvement idea about the modulation mentioned above, so it is unnecessary to give a specific PWM timing sequence diagram herein.

FIG. 15 shows PWM timing sequences of the PSDPWM_TS2 modulation strategy within the intervals from S1 to S6; the PWM timing sequences in the rest of the intervals can be deduced out according to the improvement idea about the modulation mentioned above, so it is unnecessary to give a specific PWM timing sequence diagram herein.

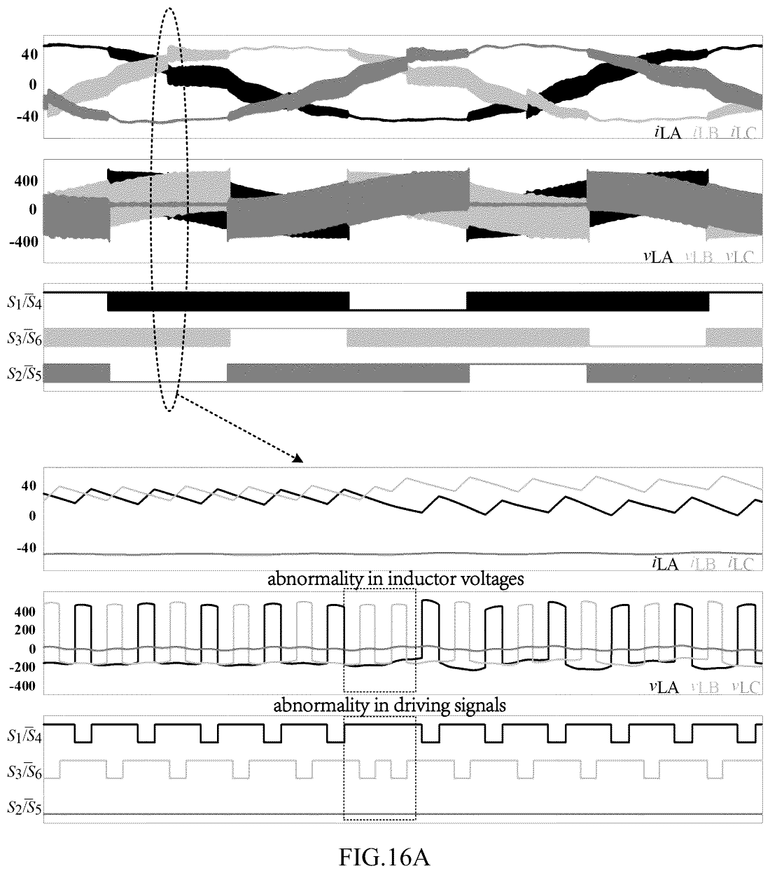

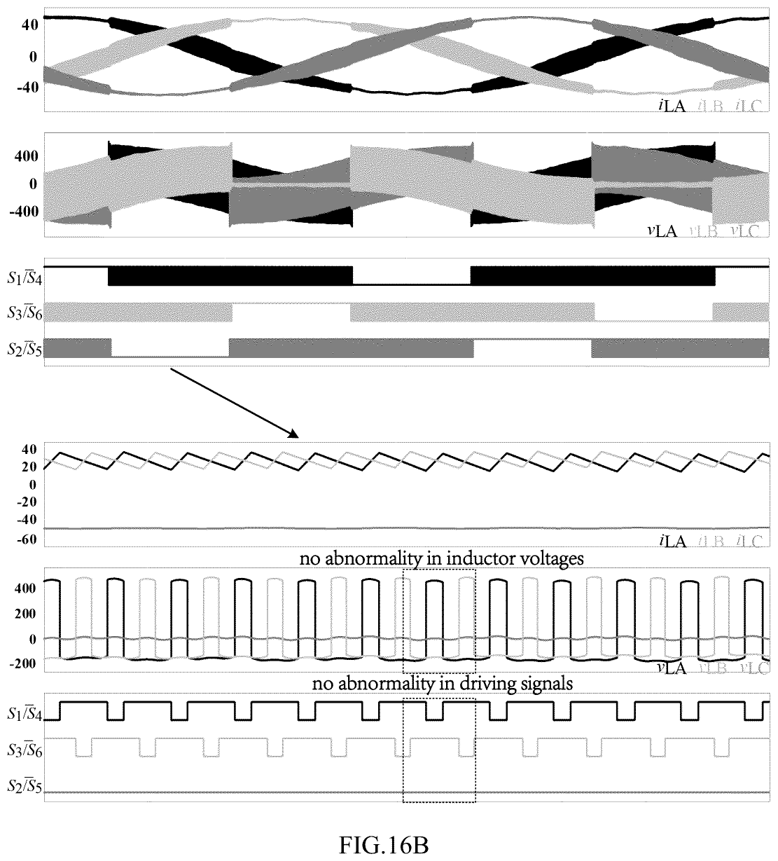

FIGS. 16A˜16B shows simulation results of the PSDPWM_1 and PSDPWM_TS1 12-interval modulation strategies at the time of updating intervals in a switching cycle. It can be seen from FIGS. 16A˜16B that the PSDPWM_TS1 modulation strategy eliminates the AC-side inductor current distortion at the time of switching intervals without changing the V_{MN} and i_{MN}.

In addition, the improvement method for the modulation strategy proposed by the present invention further includes: setting a switching time-point between any two adjacent clamping intervals as a start time-point or an end time point of the switching cycle of the driving signal.

Either the 12-interval division mode or the 6-interval division mode enables switching between intervals at an end time-point or a start timepoint of a switching cycle, so as to reduce the switching point distortion occurring to the AC-side inductor current sector.

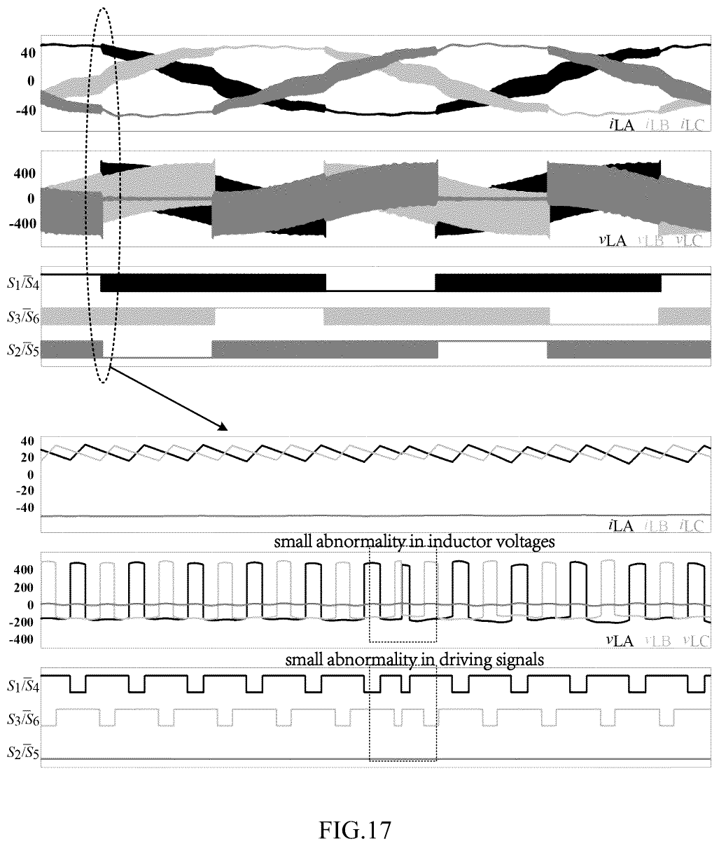

Taking the voltage of the inductor La at the time of updating from the interval 2 to the interval 3 as an example, FIG. 17 shows a simulation result of the PSDPWM_1 12-interval modulation strategy at the time of updating intervals at a start time-point or an end time-point of a switching cycle.

It can be seen from FIG. 16A that an abnormality occurs to a B-phase inductor voltage at the time of switching, resulting in a volt-second product greater than 0 in a short period of time, and the inductor current increases rapidly, generating distortion. It can be seen from FIG. 17 that an abnormality also occurs to a B-phase inductor voltage at the time of switching, but the volt-second product changes less obviously than that in FIG. 16A, so the inductor current distortion is not obvious.

In summary, the phase-shift discontinuous pulse-width modulation method proposed by the present invention is applicable to an AC/DC converter and a DC/AC converter. The phase-shift discontinuous pulse-width modulation method changes the PWM time-sequence in a switching cycle on the basis of the existing DPWM modulation strategy, and adds a phase shift between the equivalent switch driving signals of two non-clamped phases.

In an AC cycle, by way of adopting two improvement methods, it is possible for any one-phase modulation signal to optionally change the positions of the high level middle time-points of the driving signal of the phase leg unit corresponding to the modulation signal at the time of entering a clamping interval of the phase corresponding to the modulation signal, exiting a clamping interval of the phase corresponding to the modulation signal, or lying in a clamping interval of the phase corresponding to the modulation signal.

In the 12-interval division mode and the 6-interval division mode, it is possible to obviously eliminate the AC-side inductor current distortion at the time of switching intervals. In addition, for the existing multiple DPWM modulation strategies, the same idea can be adopted to improve the different DPWM modulation strategies (two improvement measure of adding a phase shift between the equivalent switch driving signals of two non-clamping phases).

The phase-shift discontinuous pulse-width modulation method proposed by the present invention can obviously decrease a common-mode voltage between a mid-point of a DC-side capacitor and a neutral point of an AC-side capacitor; in the case that the common-mode suppressor circuit is applied in the converter, the proposed phase-shift discontinuous pulse-width modulation method can also obviously decrease the common-mode current in the common-mode suppressor unit. Due to the decrease of the common-mode voltage and common-mode current, the common-mode suppressor circuit is easily applied to the AC/DC converter and the DC/AC converter, and the proposed phase-shift discontinuous pulse-width modulation method improves the quality of the AC-side current. Due to the decrease of the common-mode voltage, the mid-point of the DC-side capacitor or the neutral point of the AC-side filter capacitor can be uniformly used as a reference ground of a sampling circuit, thus it is possible to ensure that a controller operates safely and stably without an additional isolation circuit, and the proposed phase shift discontinuous pulse-width modulation method simplifies the design of the sampling circuit. Due to the decrease of the common-mode current, the AC-side filter capacitor and inductor, the switching element, and the common-mode suppressor circuit all have a decrease in loss, and the proposed phase-shift discontinuous pulse-width modulation method optimizes the efficiency of the converter.

The present invention also provides a three-phase converter that adopts the above-mentioned phase shift discontinuous pulse width modulation method, including: an A-phase leg unit, a B-phase leg unit, and a C-phase leg unit;

among the A-phase leg unit, the B-phase leg unit, and the C-phase leg unit, there is a switching element of an one-phase leg unit that can keep switched on or switched off in any switching cycle, and a phase shift ratio ΔΦ that occurs between driving signals of the switching elements of the other two one-phase leg units, so that an upper-leg switching element of each one-phase leg unit in a three-phase leg assembly is asynchronously switched on or switched off at any time-point.

By way of enabling a switching element of an one-phase leg unit to keep switched on or switched off in any switching cycle, and enabling a phase shift ratio ΔΦ to occur between driving signals of switching elements of the other two one-phase leg units, so that an upper-leg switching element of each one-phase leg unit in a three-phase leg assembly is asynchronously switched on or switched off at any time-point, it is possible for the phase-shift discontinuous pulse-width modulation method proposed by the present invention to reduce the common-mode voltage and the common-mode current between the mid-point M of the DC-side capacitor and the neutral point N of the AC-side filter capacitor, and abate the overall loss of the three-phase converter to a certain extent. In addition, adopting the phase-shift discontinuous pulse-width modulation method proposed by the present invention makes it possible to omit an isolation circuit that is additionally used for the existing DPWM modulation, and uniformly use the mid-point of the DC-side capacitor or the neutral point of the AC-side filter capacitor as a reference ground of the sampling circuit. That is, the phase-shift discontinuous pulse-width modulation method proposed by the present invention optimizes the efficiency of the three-phase converter on the basis of simplifying design of the sampling circuit and optimizing costs.

The above content is only some preferred examples of the present invention and not used to pose any limitation on the present invention, and any modifications, equivalent substitutions, improvements and the likes made within the essence and principle of the present invention shall fall within the protection scope of the present invention.

What is claimed is:

1. A phase-shift discontinuous pulse-width modulation method comprising the step of: enabling a switching element of an one-phase leg unit to keep switched on or switched off in any switching cycle, and enabling a phase shift ratio ΔΦ to occur between driving signals of switching elements of the other two one-phase leg units, during operation of a three-phase converter, so that an upper-leg switching element of each one-phase leg unit in a three-phase leg assembly is asynchronously switched on or switched off at any time-point.

2. The phase-shift discontinuous pulse-width modulation method according to claim 1, wherein the step of enabling a switching element of an one-phase leg unit to keep switched on or switched off in any switching cycle, and enabling a phase shift ratio ΔΦ to occur between driving signals of switching elements of the other two one-phase leg units includes:
in the case that a modulation signal of the switching element of the one-phase leg unit in said three-phase converter is clamped to a peak value of a carrier wave, setting at most one one-phase driving signal of upper-leg switching elements of the other two one-phase leg units at any time-point to be a high level; in the case that a modulation signal of the switching element of the one-phase leg unit in said three-phase converter is clamped to a valley value of a carrier wave, setting at least one one-phase driving signal of upper-leg switching elements of the other two one-phase leg units at any time-point to be a high level.

3. The phase-shift discontinuous pulse-width modulation method according to claim 1, wherein the step of enabling a switching element of an one-phase leg unit to keep switched on or switched off in any switching cycle, and enabling a phase shift ratio ΔΦ to occur between driving signals of switching elements of the other two one-phase leg units further includes:
a first modulation strategy: enabling the switching element of the one-phase leg unit in said three-phase converter to keep switched on or switched off; among the other two one-phase leg units, setting a high level middle time-point of a driving signal of an upper-leg switching element of the leg unit with a high phase voltage to be Φ₁Tₛ, while setting a high level middle time-point of a driving signal of an upper-leg switching element of the leg unit with a low phase voltage to be Φ₂Tₛ; and
a second modulation strategy: enabling the switching element of the one-phase leg unit in said three-phase converter to keep switched on or switched off; among the other two one-phase leg units, setting a high level middle time-point of a driving signal of an upper-leg switching element of the leg unit with a low phase voltage to be Φ₁Tₛ, while setting a high level middle time-point of a driving signal of an upper-leg switching element of the leg unit with a high phase voltage to be Φ₂Tₛ,
where, Ts represents a cycle of said driving signal, ΔΦ=Φ₂−Φ₁, and Φ₂>Φ₁.

4. The phase-shift discontinuous pulse-width modulation method according to claim 3, wherein an AC cycle of said three-phase converter is divided into 3Z clamping intervals, and each of said clamping intervals has at least one said switching cycle, a clamping interval where any phase modulation signal is clamped to a peak value of a carrier wave or a valley value of a carrier wave is a clamping interval of a phase corresponding to said modulation signal;
where, Z is a positive integer.

5. The phase-shift discontinuous pulse-width modulation method according to claim 4, wherein a switching time-point between any two of said adjacent clamping intervals is set as a start time-point or an end time point of a switching cycle of said driving signal.

6. The phase-shift discontinuous pulse-width modulation method according to claim 4, wherein in a clamping interval where any one of said one-phase modulation signals ascends and descends, positions of high level middle time-points of a driving signal of an upper-leg switching element of a leg unit corresponding to said modulation signal differ from each other, so that an upper-leg switching element of each one-phase leg unit in a three-phase leg assembly is asynchronously switched on or switched off at any time-point.

7. The phase-shift discontinuous pulse-width modulation method according to claim 6, wherein any one-phase modulation signal is optional to change the positions of the high level middle time-points of the driving signal of the phase leg unit corresponding to said modulation signal at the time of entering the clamping interval of the phase corresponding to said modulation signal, exiting the clamping interval of the phase corresponding to said modulation signal, or lying in the clamping interval of the phase corresponding to said modulation signal.

8. The phase-shift discontinuous pulse-width modulation method according to claim 7, wherein the AC cycle of said three-phase converter is divided into 6 clamping intervals, and switching time-points of said 6 clamping intervals are set as t₁, t₂, t₃, t₄, t₅ and t₆ in turn;
an A-phase modulation signal of said three-phase converter is set to change the high level middle time-points of the upper-leg switching element at t₁, t₃, t₄, and t₆, a B-phase modulation signal of said three-phase converter is set to change the high level middle time-points of the upper-leg switching element at t₂, t₃, t₅, and t₆, a C-phase modulation signal of said three-phase converter is set to change the high level middle time-points of the upper-leg switching element at t₁, t₂, t₄, and t₅.

9. The phase-shift discontinuous pulse-width modulation method according to claim 7, wherein the AC cycle of said three-phase converter is divided into 12 clamping intervals, and switching time-points of said 12 clamping intervals are set as t₀, t₁, t₂, t₃, t₄, t₅, t₆, t₇, t₈, t₉, t₁₀ and t₁₁ in turn,
when said three-phase converter executes the first modulation strategy, an A-phase modulation signal of said three-phase converter is set to change the high level middle time-points of the upper-leg switching element at t₀, t₁, t₅, t₆, t₇ and t₁₁, a B-phase modulation signal of said three-phase converter is set to change the high level middle time-points of the upper-leg switching element at t₃, t₄, t₅, t₉, t₁₀ and t₁₁, a C-phase modulation signal of said three-phase converter is set to change the high level middle time-points of the upper-leg switching element at t₁, t₂, t₃, t₇, t₈ and t₉.

10. A three-phase converter that adopts the phase shift discontinuous pulse width modulation method according to claim 1, comprising: an A-phase leg unit, a B-phase leg unit, and a C-phase leg unit; wherein among said A-phase leg unit, said B-phase leg unit, and said C-phase leg unit, there is a switching element of an one-phase leg unit that keeps switched on or switched off in any switching cycle, and a phase shift ratio ΔΦ that occurs between driving signals of switching elements of the other two one-phase leg units, so that an upper-leg switching element of each one-phase leg unit in a three-phase leg assembly is asynchronously switched on or switched off at any time-point.

11. A three-phase converter that adopts the phase shift discontinuous pulse width modulation method according to claim 7, comprising: an A-phase leg unit, a B-phase leg unit, and a C-phase leg unit; wherein among said A-phase leg unit, said B-phase leg unit, and said C-phase leg unit, there is a switching element of an one-phase leg unit that keeps switched on or switched off in any switching cycle, and a phase shift ratio ΔΦ that occurs between driving signals of switching elements of the other two one-phase leg units, so that an upper-leg switching element of each one-phase leg unit in a three-phase leg assembly is asynchronously switched on or switched off at any time-point.
